(19) United States
(12) Patent Application Publication
(10) Pub. No.: US 2021/0160025 A1
(43) Pub. Date: May 27, 2021

(54) METHODS AND APPARATUSES FOR PHASE TRACKING REFERENCE SIGNAL CONFIGURATION

(71) Applicant: NEC CORPORATION, Tokyo (JP)

(72) Inventors: Yukai GAO, Beijing (CN); Gang WANG, Beijing (CN)

(73) Assignee: NEC CORPORATION, Tokyo (JP)

(21) Appl. No.: 16/610,759

(22) PCT Filed: Nov. 9, 2017
(86) PCT No.: PCT/CN2017/110231

§ 371 Date: Nov. 4, 2019

(51) Int. Cl. H04L 5/00; H04L 27/26

(52) U.S. Cl. CPC H04L 5/0048; H04L 5/0094; H04L 27/2613; H04L 5/0026

(57) ABSTRACT

The present disclosure provides methods and apparatuses for Phase Tracking Reference Signal (PTRS) configuration. In example embodiments, a method implemented in a network device is provided. According to the method, a first configuration for transmitting a PTRS is determined. The first configuration indicates at least one of the following: a first density of the PTRS in time domain, a second density of the PTRS infrequency domain, first resource allocation for the PTRS in time domain, and second resource allocation for the PTRS in frequency domain. Information on the first configuration is transmitted to a terminal device.

### TECHNICAL FIELD

Embodiments of the present disclosure generally relate to the field of telecommunication, and in particular, to methods and apparatuses for Phase tracking Reference Signal (PTRS) configuration.

### BACKGROUND

With the development of communication technologies, multiple types of services or traffic have been proposed, for example, enhanced mobile broadband (eMBB) generally requiring high data rate, massive machine type communication (mMTC) typically requiring long battery lifetime, and ultra-reliable and low latency communication (URLLC). Meanwhile, multi-antenna schemes, beam management, reference signal transmission, and so on, are studied for new radio access (NR).

In NR, PTRS can be introduced to enable compensation for phase noise. Generally, the phase noise increases as the carrier frequency increases, so PTRS can be used to eliminate phase noise for a wireless network operating in high frequency bands. For an OFDM-based system, it has been agreed that a PTRS port can be associated with a Demodulation Reference Signal (DMRS) port, and a terminal device in the system can assume same precoding for a DMRS port and a PTRS port. Moreover, front-loaded DMRS is supported for fast decoding and additional DMRSs in addition to the front-loaded DMRS are supported for high-speed/high Doppler scenario.

Currently, PTRS mapping patterns in time and frequency domains have been studied, but detailed patterns have not been designed yet. For example, PTRS density in time domain can be associated with Modulation and Coding Scheme (MCS) being scheduled, while PTRS density in frequency domain can be associated with a scheduled bandwidth. However, the PTRS density in time domain may be related to the number of additional DMRSs. That is, some PTRS mapping patterns in time domain may not be needed. Furthermore, without any restrictions, PTRS mapping patterns in frequency domain may cause interference and performance loss. In this case, a scheme for restricting PTRS configurations needs to be considered, so as to reduce the overhead and interference.

### SUMMARY

In general, example embodiments of the present disclosure provide methods and apparatuses for PTRS configuration.

In a first aspect, there is provided a method implemented in a network device. According to the method, a first configuration for transmitting a Phase Tracking Reference Signal (PTRS) is determined. The first configuration indicates at least one of the following: a first density of the PTRS in time domain, a second density of the PTRS in frequency domain, first resource allocation for the PTRS in time domain, and second resource allocation for the PTRS in frequency domain. Information on the first configuration is transmitted to a terminal device.

In a second aspect, there is provided a method implemented in a terminal device. According to the method, information on a first configuration for transmitting a Phase Tracking Reference Signal (PTRS) is received from a network device. The first configuration is determined at least based on the information. The first configuration indicates at least one of the following: a first density of the PTRS in time domain, a second density of the PTRS in frequency domain, first resource allocation for the PTRS in time domain, and second resource allocation for the PTRS in frequency domain.

In a third aspect, there is provided a network device. The network device comprises a processor and a memory coupled to the processor. The memory stores instructions that when executed by the processor, cause the network device to performs actions. The actions comprise: determining a first configuration for transmitting a Phase Tracking Reference Signal (PTRS), the first configuration indicating at least one of the following: a first density of the PTRS in time domain, a second density of the PTRS in frequency domain, first resource allocation for the PTRS in time domain, and second resource allocation for the PTRS in frequency domain; and transmitting information on the first configuration to a terminal device.

In a fourth aspect, there is provided a terminal device. The terminal device comprises a processor and a memory coupled to the processor. The memory stores instructions that when executed by the processor, cause the terminal device to performs actions. The actions comprise: receiving, from a network device, information on a first configuration for transmitting a Phase Tracking Reference Signal (PTRS); and determining the first configuration at least based on the information, the first configuration indicating at least one of the following: a first density of the PTRS in time domain, a second density of the PTRS in frequency domain, first resource allocation for the PTRS in time domain, and second resource allocation for the PTRS in frequency domain.

In a fifth aspect, there is provided a computer readable medium having instructions stored thereon. The instructions, when executed on at least one processor, cause the at least one processor to carry out the method according to the first aspect.

In a sixth aspect, there is provided a computer readable medium having instructions stored thereon. The instructions, when executed on at least one processor, cause the at least one processor to carry out the method according to the second aspect.

In a seventh aspect, there is provided a computer program product that is tangibly stored on a computer readable storage medium. The computer program product includes instructions which, when executed on at least one processor, cause the at least one processor to carry out the method according to the first aspect or the second aspect.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 is a block diagram of a communication environment in which embodiments of the present disclosure can be implemented;

FIG. 2 illustrates processes for PTRS transmission according to some embodiments of the present disclosure;

FIG. 3 shows a flowchart of an example method 300 for PTRS configuration according to some embodiments of the present disclosure;

FIGS. 4A-4C show example resource structures for data transmission according to some embodiments of the present disclosure;

FIGS. 5A-5B show example resource structures for PTRS transmission according to some embodiments of the present disclosure;

FIGS. 6A-6D show example configuration types for DMRS transmission;

FIGS. 7A-7B show different PTRS mapping patterns for different DMRS types according to some embodiments of the present disclosure;

FIG. 8 shows an example PTRS mapping pattern according to some embodiments of the present disclosure;

FIG. 9 shows a flowchart of an example method 900 in accordance with some embodiments of the present disclosure; and

FIG. 10 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “network device” or “base station” (BS) refers to a device which is capable of providing or hosting a cell or coverage where terminal devices can communicate. Examples of a network device include, but not limited to, a Node B (NodeB or NB), an Evolved NodeB (eNodeB or eNB), a next generation NodeB (gNB) a Remote Radio Unit (RRU), a radio head (RH), a remote radio head (RRH), a low power node such as a femto node, a pico node, and the like. For the purpose of discussion, in the following, some embodiments will be described with reference to gNB as examples of the network device.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, image capture devices such as digital cameras, gaming devices, music storage and playback appliances, or Internet appliances enabling wireless or wired Internet access and browsing and the like. For the purpose of discussion, in the following, some embodiments will be described with reference to UE as examples of the terminal device.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “at least in part based on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

Communication discussed in the present disclosure may conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA) and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

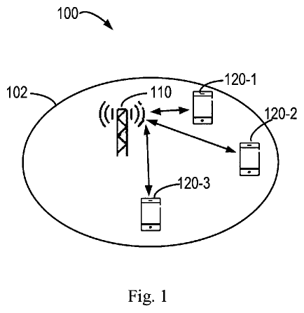

FIG. 1 shows an example communication network 100 in which embodiments of the present disclosure can be implemented. The network 100 includes a network device 110 and three terminal devices 120-1 and 120-3 (collectively referred to as terminal devices 120 or individually referred to as terminal device 120) served by the network device 110. The coverage of the network device 110 is also called as a cell 102. It is to be understood that the number of base stations and terminal devices is only for the purpose of illustration without suggesting any limitations. The network 100 may include any suitable number of base stations and the terminal devices adapted for implementing embodiments of the present disclosure. Although not shown, it would be appreciated that there may be one or more neighboring cells adjacent to the cell 102 where one or more corresponding network devices provides service for a number of terminal device located therein.

The network device 110 may communicate with the terminal devices 120. The communications in the network 100 may conform to any suitable standards including, but not limited to, Long Term Evolution (LTE), LTE-Evolution, LTE-Advanced (LTE-A), Wideband Code Division Multiple Access (WCDMA), Code Division Multiple Access (CDMA) and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

Conventionally, a network device (for example, an eNB or a gNB) may transmit downlink reference signals (RSs) such as Demodulation Reference Signal (DMRS), Channel State Information-Reference Signal (CSI-RS), Sounding Reference Signal (SRS), Phase Tracking Reference Signal (PTRS), fine time and frequency Tracking Reference Signal (TRS) and the like. A terminal device (for example, a user equipment) in the system may receive the downlink RSs on allocated resources. The terminal device may also transmit uplink RSs to the network device on corresponding allocated resources. For indicating the allocated resources and/or other necessary information for the RSs, the network device may transmit RS configurations to the terminal device prior to the transmissions of the RSs.

In addition to normal data communications, the network device 110 may transmit downlink reference signals (RSs) in a broadcast, multi-cast, and/or unicast manners to one or more of the terminal devices 120 in a downlink (DL). Similarly, one or more of the terminal devices 120 may transmit RSs to the network device 110 in an uplink (UL). As used herein, a “downlink” refers to a link from a network device to a terminal device, while an “uplink” refers to a link from the terminal device to the network device. Examples of the RSs may include but are not limited to downlink or uplink Demodulation Reference Signal (DMRS), Channel State Information-Reference Signal (CSI-RS), Sounding Reference Signal (SRS), Phase Tracking Reference Signal (PTRS), fine time and frequency Tracking Reference Signal (TRS) and so on.

Generally speaking, a RS is a signal sequence (also referred to as “RS sequence”) that is known by both the network device 110 and the terminal devices 120. For example, a RS sequence may be generated and transmitted by the network device 110 based on a certain rule and the terminal device 120 may deduce the RS sequence based on the same rule. In transmission of downlink and uplink RSs, the network device 110 may allocate corresponding resources (also referred to as “RS resources”) for the transmission and/or specify which RS sequence is to be transmitted.

In some scenarios, both the network device 110 and the terminal device 120 are equipped with multiple antenna ports (or antenna elements) and can transmit specified RS sequences with the antenna ports (antenna elements). A set of RS resources associated with a number of RS ports are also specified. A RS port may be referred to as a specific mapping of part or all of a RS sequence to one or more resource elements (REs) of a resource region allocated for RS transmission in time, frequency, and/or code domains. Such resource allocation information may be indicated to the terminal device 120 prior to the transmission of the RSs.

In NR, PTRS can be introduced to enable compensation for phase noise. Generally, the phase noise increases as the carrier frequency increases, so PTRS can be used to eliminate phase noise for a wireless network operating in high frequency bands. For an OFDM-based system, it has been agreed that a PTRS port can be associated with a DMRS port. Different DMRS ports may be multiplexed based on Code Division Multiplexing (CDM) technology in time and/or frequency domain, and/or based on Frequency Division Multiplexing (FDM) technology. For example, a group of DMRS ports multiplexed based on CDM technology can also be referred as a “CDM group”. Moreover, front-loaded DMRS is supported for fast decoding and additional DMRSs in addition to the front-loaded DMRS are supported for high-speed/high Doppler scenario.

It has been learned that, PTRS density in time domain can be associated with Modulation and Coding Scheme (MCS) being scheduled, while PTRS density in frequency domain can be associated with a scheduled bandwidth. However, the PTRS density in time domain may be related to the number of additional DMRSs. That is, some PTRS mapping patterns in time domain may not be needed. Furthermore, without any restrictions, PTRS mapping patterns in frequency domain (for example, between different CDM groups) may cause interference and performance loss.

In order to solve the problems above and one or more of other potential problems, a solution for PTRS configuration is provided in accordance with example embodiments of the present disclosure. With the solution, the signaling overhead for indicating the PTRS configuration as well as the interference caused by PTRS mapping between different CDM groups can be reduced.

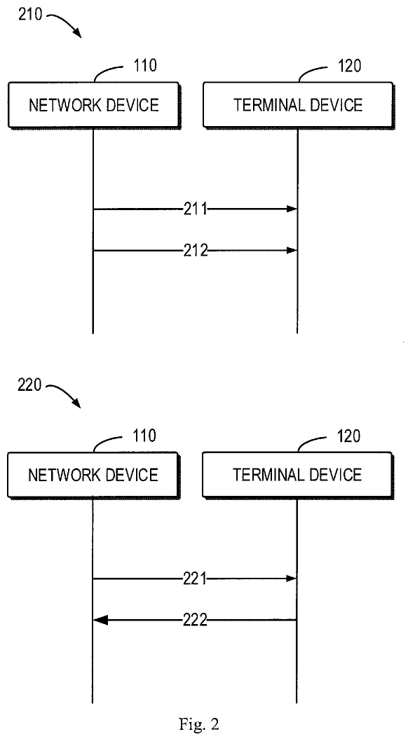

Principle and implementations of the present disclosure will be described in detail below with reference to FIGS. 2-9, in which FIG. 2 shows two processes 210 and 220 for PTRS transmission according to some embodiments of the present disclosure. For the purpose of discussion, the processes 210 and 220 will be described with reference to FIG. 1. The processes 210 and 220 may involve the network device 110 and one or more terminal devices 120 served by the network device 110.

As shown in FIG. 2, the process 210 is directed to the case of DL PTRS transmission. In one embodiment, the network device 110 may indicate (211) a PTRS configuration to a terminal device 120. For example, the PTRS configuration may indicate that a PTRS port for PTRS transmission is associated with a DMRS port. The network device 120 may transmit (212) a PTRS based on the PTRS configuration. The terminal device 120 may receive the PTRS configuration from the network device 110, and detect the PTRS based on the received PTRS configuration to compensate phase noise. The process 220 is directed to the case of UL RS transmission. In another embodiment, the network device 110 may indicate (221) a PTRS configuration to the terminal device 120. For example, the PTRS configuration may indicate that a PTRS port for PTRS transmission is associated with a DMRS port. The terminal device 120 may receive from the network device 110 the PTRS configuration, and may transmit (222) the PTRS based on the received PTRS configuration. The network device 110 may detect the PTRS based on the PTRS configuration to compensate phase noise.

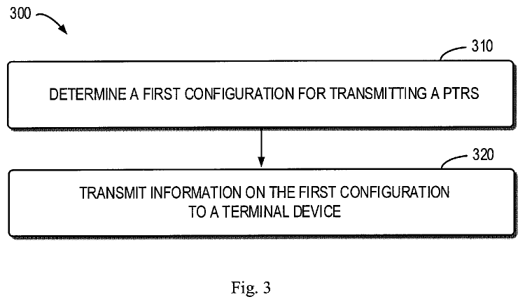

FIG. 3 shows a flowchart of an example method 300 for PTRS configuration according to some embodiments of the present disclosure. The method 300 can be implemented at the network device 110 as shown in FIG. 1. For the purpose of discussion, the method 300 will be described from the perspective of the network device 110 with reference to FIG. 1.

In act 310, the network device 110 determines a first configuration for transmitting a PTRS. In some embodiments, the first configuration may indicate at least one of the following: a first density of the PTRS in time domain, a second density of the PTRS in frequency domain, first resource allocation for the PTRS in time domain, and second resource allocation for the PTRS in frequency domain.

For an OFDM-based system, the densities of PTRS in time domain usually include every 4^{th} symbol (that is, ¼), every 2^{nd} symbol (that is, ½), and every symbol (that is, 1). The density of PTRS in time domain can be associated with the scheduled MCS. The time density of PTRS is expected to increase with increasing the scheduled MCS. For example, Table 1 shows typical available densities of PTRS in time domain and Table 2 shows the association between the scheduled MCS and the time density of PTRS. In Table 1, MCS₁˜MCS₄ may represent predetermined and/or configured (such as, via RRC signaling) MCS thresholds.

TABLE 1
Available densities Of PTRS in time domain
0
1
½
¼

TABLE 2

| Scheduled MCS | Time density of PTRS |
|---|---|
| 0 <= MCS < MCS₁ | No PTRS |
| MCS₁ <= MCS < MCS₂ | TD₁, e.g. ¼ |
| MCS₂ <= MCS < MCS₃ | TD₂, e.g. ½ |
| MCS₃ <= MCS < MCS₄ | TD₃, e.g. 1 |

For an OFDM-based system, the frequency densities of PTRS usually include occupying one subcarrier (not necessarily in all REs, depending on the time density) in at least one of every RB (that is, 1), every 2^{nd} RB (that is, ½), every 3^{rd} RB (that is, ⅓), every 4^{th} RB (that is, ¼), every 8^{th} RB (that is, ⅛) or every 16^{th} RB (that is, 1/16). The density of PTRS in frequency domain can be associated with the scheduled bandwidth (that is, the number of scheduled RBs). The frequency density of PTRS is expected to decrease with increasing the scheduled bandwidth. For example, Table 3 shows the association between the scheduled bandwidth (represented as N_{RB}) and the frequency density of PTRS. In Table 3, N_{RB1}˜N_{RB5} may represent predetermined and/or configured (such as, via RRC signaling) bandwidth thresholds.

TABLE 3

| Scheduled Bandwidth | Frequency density of PTRS |
|---|---|
| 0 <= N_{RB} < N_{RB1} | No PTRS |
| N_{RB1} <= N_{RB} < N_{RB2} | FD₁, e.g. 1 |
| N_{RB2} <= N_{RB} < N_{RB3} | FD₂, e.g. ½ |
| N_{RB3} <= N_{RB} < N_{RB4} | FD₃, e.g. ⅓ |
| N_{RB4} <= N_{RB} < N_{RB5} | FD₄, e.g. ¼ |
| or N_{RB4} <= N_{RB} | |

In some embodiments, for different values of some parameters, available densities of PTRS in time domain may be different. In one embodiment, the parameters may include at least one of the following: the number of additional DMRSs, the number of symbols for transmitting the front-loaded DMRS, the number of symbols for control channel transmission, the number of DMRS ports, the number of CDM groups, a frequency range, and a subcarrier spacing (SCS) value. For example, the total set of time densities of PTRS as shown in Table 1 can be represented as {0, TD₁, TD₂, TD₃}. In one embodiment, depending on different values of the parameters, a set of candidate densities of PTRS in time domain can be restricted to a subset of {0, TD₁, TD₂, TD₃}. As such, the first density of PTRS in time domain indicated by the first configuration can be selected from the set of candidate densities.

In some embodiments, the set of candidate densities can be selected from the total set of time densities by configuring corresponding MCS thresholds in Table 2. For example, in one embodiment, a time density in the total set of time densities may be unavailable. This can be achieved by setting two corresponding MCS thresholds to be the same in the row for the unavailable density. For example, if there is no configuration of “No PTRS”, MCS₁ may be configured to be 0 or 1. For another example, if there is no configuration of time density TD, MCS₁ may be configured to be the same as MCS₂. For another example, if there is no configuration of time density TD₂, MCS₂ may be configured to be the same as MCS₃. For another example, if there is no configuration of time density TD₃, MCS₃ may be configured to be the same as MCS₄.

In NR, it has been agreed that the PTRS is not transmitted in OFDM symbols that contain Physical Downlink Shared Channel (PDSCH)/Physical Uplink Shared Channel (PUSCH) DMRS. Moreover, the PTRS is not transmitted in REs that are overlapped with a configured search space for blind detection of control channel (also called as a “CORESET”).

In one embodiment, for example, the configured CORESET includes 3 symbols, and/or the number of symbols for transmitting the front-loaded DMRS is 1, and/or the number of additional DMRSs is 2 or 3. In this event, the density of ¼ and/or ½ may be not supported (for example, MCS, is always the same as MCS₂, and/or MCS₂ is always the same as MCS₃). That is, the set of candidate densities of PTRS in time domain can be restricted to {0, TD₂, TD₃} (that is, {0, ½, 1}) or restricted to {0, TD₃} (that is, {0, 1}).

In one embodiment, for example, the number of symbols for transmitting the front-loaded DMRS is 2, and/or the frequency range is above 6 GHz, and/or SCS=60 kHz or 120 kHz. In this event, the density of PTRS in time domain may be fixed to 1, or may be configurable between 0 and 1, or the density of ¼ may not be supported. In addition, the density 0 may be not supported. That is, the set of candidate densities of PTRS in time domain can be restricted to one of: {TD₃}, {0, TD₃}, {0, TD₂, TD₃}, {TD₁, TD₂} or {TD₁, TD₂, TD₃}.

It is to be understood that the above examples are only for the purpose of illustration without suggesting any limitations to the present disclosure. The present disclosure is not necessarily limited to the above examples as illustrated above. Rather, more features and/or examples, such as with respect to different frequency ranges and/or values of subcarrier spacing, can be conceived by those skilled in the art in view of the teachings of the present disclosure.

In some embodiments, for slot-based and/or non-slot based transmission (UL or DL), time resources (for example, corresponding symbols) allocated for the transmission can be divided into one or more regions. It is to be noted that frequency resources (for example, corresponding resource blocks) allocated for the transmission may be contiguous or non-contiguous. Specifically, in one embodiment, respective resource allocations in frequency domain in different regions may be different.

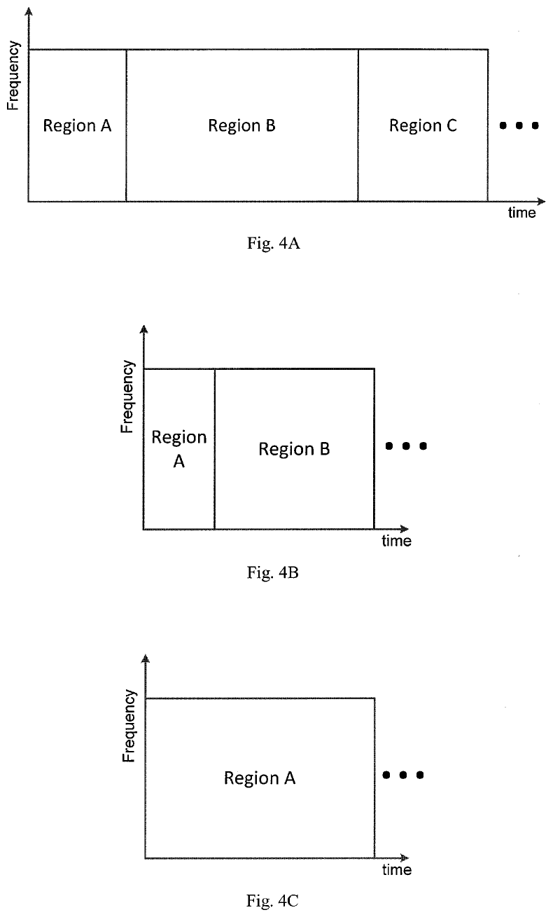

In some embodiments, for slot-based transmission, a predetermined set of symbols can be divided into 1˜3 regions. For example, an example resource structure for slot-based transmission is shown in FIG. 4A, where the predetermined set of symbols allocated for the transmission is divided into three regions. Region A may include symbol(s) for control channel transmission or symbol(s) for CORESET(s). Region B may include symbol(s) allocated for data transmission (such as, PDSCH or PUSCH). It is to be noted that, in Region B, other signals or channels can also be transmitted. Region C may include unknown or reserved symbol(s), for example, which are not used for DL or UL transmission. For example, in some embodiments, the total number of symbols in one slot may be 14. The number of symbols in Region A may be 0˜3. The number of symbols in Region C may be 0˜6. The number of symbols in Region B may be not less than 1.

In some embodiments, for non-slot based transmission, a predetermined set of symbols can be divided into one or two regions. For example, an example resource structure for non-slot based transmission is shown in FIG. 4B, where the predetermined set of symbols allocated for the transmission is divided into two regions (Regions A and B). For example, the total number of symbols in one mini-slot may be any of 1, 2, 3, 4, 5, 6, 7, 8, 9, 10, 11, 12 and 13. For example, the total number of symbols for non-slot based scheduling may be any of 2, 4 and 7. The number of symbols in Region A may be 0˜3. The number of symbols in Region B may be 1˜7. Another example resource structure for non-slot based transmission is shown in FIG. 4C, where the predetermined set of symbols allocated for the transmission is divided into one region (Region A). For example, the number of symbols in Region A may be equal to or less than the total number of symbols in one mini-slot.

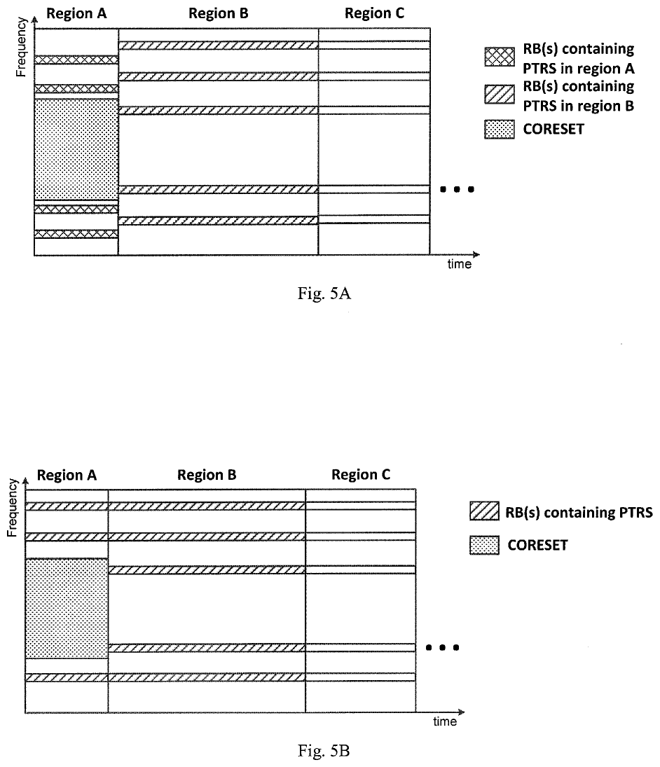

In some embodiments, the PTRS configuration in frequency domain can be determined based on the divided one or more regions. Specifically, in Regions A and B as shown in FIGS. 4A-4C, if PTRS exists, respective PTRS configurations for different regions can be determined based on different parameters and/or configurations. For example, respective PTRS densities in frequency domain and/or RB locations or indices for PTRS for Regions A and B may be different. In this regard, FIG. 5A shows an example structure of resource allocation for PTRS in frequency domain.

As shown in FIG. 5A, in one embodiment, the resource allocations in frequency domain for Regions A and B may be different. For example, the number of RBs allocated in Region A may be represented as N_a, while the number of RBs allocated in Region B may be represented as N_b. In one embodiment, N_a is different from N_b. Specifically, as shown in FIG. 5A, the RB(s) allocated in Region A should not be overlapped with the configured CORESET. In some embodiments, for different regions, PTRS densities in frequency domain may be determined based on different number of RBs. As shown in FIG. 5A, the number of RBs containing PTRS in Region A is different from the number of RBs containing PTRS in Region B. In some embodiments, for different regions, the mapping of PTRS to RBs may be determined based on at least one of the following: different numbers of RBs, different PTRS densities in frequency domain and/or different RB offset values.

Alternatively, in some other embodiments, the PTRS configuration in frequency domain can be determined based on the divided one or more regions. Specifically, in Region B as shown in FIGS. 4A-4C, if PTRS exists, the resource allocation for PTRS can be determined based on at least one of the following: resource allocation, the PTRS density in frequency domain, and the RB offset value. However, in Region A, if PTRS exists, the resource allocation for PTRS can be determined based on that in Region B. For example, the RB(s) containing PTRS in region A may be included in the RB(s) containing PTRS in region B. Moreover, the RB(s) containing PTRS in region A should not be overlapped with the configured CORESET. In this regard, FIG. 5B shows an example structure of resource allocation for PTRS in frequency domain.

As shown in FIG. 5B, in one embodiment, for example, the RB(s) containing PTRS in region B may be not overlapped with the configured CORESET in Region A. In this event, the RB(s) containing PTRS in region A may be same as the RB(s) containing PTRS in region B. In another embodiment, for example, all of the RB(s) containing PTRS in region B is overlapped with the configured CORESET in Region A. In this event, there may be no PTRS transmission in Region A.

It is to be noted that, the CORESET as shown in FIGS. 5A and 5B may be continuous or non-contiguous in frequency domain. In some cases, there may be more than one CORESET in Region A. It is also to be noted that, PTRS mapping in time domain as shown in FIGS. 5A and 5B may be contiguous or non-contiguous, which depends on the resource allocation for data transmission in time domain, the PTRS density in time domain and DMRS configuration. For example, PTRS may be transmitted in every K symbols except those containing DMRS, where K is any of 1, 2 or 4.

In some embodiments, at least for a certain PTRS time density and/or a certain number of symbols for CORESET, there may be no PTRS transmission in Region A, even if the PTRS time and/or frequency density is not 0. For example, there may be no PTRS transmission in Region A if the PTRS time density is ¼. For another example, there may be no PTRS transmission in Region A if the number of symbols for CORESET is 1 and/or 2. Obviously, if there is no symbol in Region A, there will be no PTRS transmission in Region A. In some embodiments, if the PTRS time and/or frequency density is not 0, the PTRS mapping in time domain may start from the symbol after the CORESET(s).

In some embodiments, the first symbol in Region A may always contain PTRS if PTRS time and/or frequency density is not 0.

In some embodiments, the PTRS configuration in frequency domain can be determined based on the PTRS density in frequency domain, the scheduled bandwidth, a RB and/or resource element (RE) offset and a predetermined and/or configured type of resource allocation, and so on. For example, the PTRS configuration in frequency domain may indicate the resource mapping at RB and/or RE level.

In some embodiments, for example, virtual RB indices may be used for PTRS mapping at RB level. The PTRS mapping in frequency domain may skip some RBs and/or REs. In one embodiment, the skipped RBs may be those containing other RSs (such as, CSI-RS, TRS, synchronization signal block (SSB)) or channels, where PTRS may be punctured. In another embodiment, the skipped RBs may be those configured to contain no PTRS. The PTRS mapping can be applied to remaining RBs by indexing the remaining RBs with respective virtual RB indices. That is, the virtual RB indices may not index some RBs. If the number of indexed RBs does not satisfy the frequency density of PTRS, the PTRS mapping will continue by indexing the rest of RBs (except the skipped RBs and the RBs already allocated for PTRS) with respective virtual RB indices. The PTRS mapping will not end until the number of indexed RBs containing PTRS satisfies the frequency density of PTRS or there are no remaining RBs. Specifically, in one embodiment, if the number of remaining RBs is not enough to reach the frequency density of PTRS, each of the remaining RBs may contain PTRS.

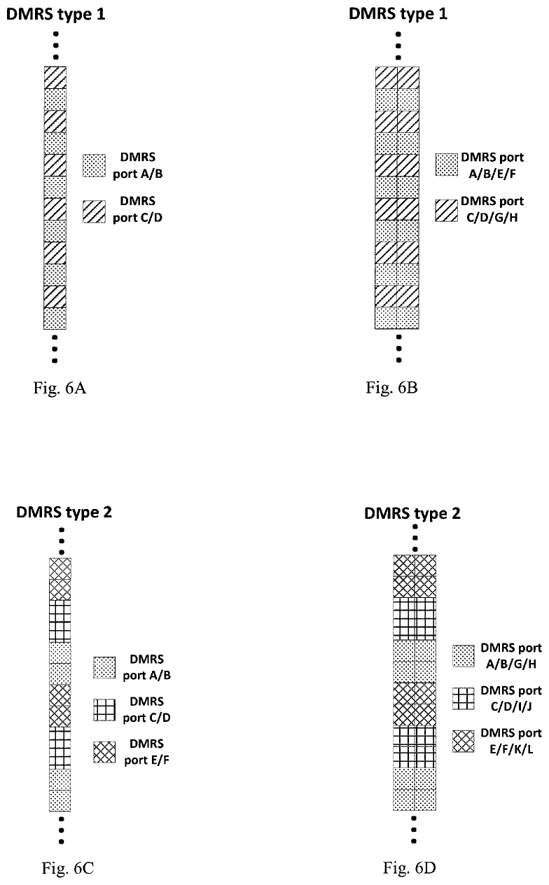

In some embodiments, as described above, a PTRS port can be associated with a DMRS port. A DMRS port may belong to one CDM group and occupy several REs within one RB. For example, as agreed in 3GPP specification works, there are two types (configuration patterns) of DMRS. For DMRS type 1, one or two symbols can be supported. As shown in FIG. 6A, for DMRS type 1 associated with one symbol, up to 4 DMRS ports (represented as DMRS ports A-D) can be supported. As shown in FIG. 6B, for DMRS type 1 associated with two symbols, up to 8 DMRS ports (represented as DMRS ports A-H) can be supported. For example, for DMRS type 1, there may be two CDM groups. One CDM group may occupy REs with even indices within one RB, for example, REs 0, 2, 4, 6, 8 and 10, where the RE index starts from 0. The other CDM group may occupy REs with odd indices within on RB, for example, REs 1, 3, 5, 7, 9 and 11, where the RE index starts from 0. For DMRS type 2, one or two symbols can be supported. As shown in FIG. 6C, for DMRS type 2 associated with one symbol, up to 6 DMRS ports (represented as DMRS ports A-F) can be supported. As shown in FIG. 6D, for DMRS type 2 associated with two symbols, up to 12 DMRS ports (represented as DMRS ports A-L) can be supported. For example, for DMRS type 2, there may be three CDM groups. One CDM group may occupy REs 0, 1, 6 and 7; one CDM group may occupy REs 2, 3, 8 and 9; and one CDM group may occupy REs 4, 5, 10 and 11, where the RE index starts from 0. As shown in FIGS. 6A-6D, different fill patterns may represent different CDM groups.

In some embodiments, in frequency domain, a RE offset can be used for selecting subcarrier for mapping PTRS within one RB. In one embodiment, the RE offset can be determined from at least one of following predetermined parameters: an associated DMRS port index, a scrambling identity (SCID), a cell identity, and so on. In one embodiment, the RE offset can be explicitly configured by Radio Resource Control (RRC) parameter “PTRS-RE-offset”.

In some embodiments, the selected subcarrier for mapping PTRS may be restricted with a frequency range within the RB(s) containing PTRS. For example, in one embodiment, the frequency region within the RB may be configured, for example, through higher layer signaling (such as RRC and/or Medium Access Control (MAC) Control Element (CE)) and/or dynamic signaling (such as downlink control information (DCI)). In one embodiment, the frequency region within the RB may include REs at the same frequency locations with those occupied by an associated DMRS port. In one embodiment, a subset of DMRS ports for DL or UL data transmission can be configured, and there may be several REs within one of the configured subset of DMRS ports. The restricted frequency region for PTRS may be same as or included in the REs of the configured subset of DMRS ports. In some embodiments, one or more DL DMRS CDM groups may be configured for rate matching. In this event, the selected subcarrier for mapping PTRS may not be overlapped with the REs occupied by the configured one or more CDM groups.

As shown in FIGS. 6A and 6B, for DMRS type 1, there may be two CDM groups, such as group 0 and group 1.

In some embodiments, the PTRS port may be associated with DMRS CDM group 0, such as DMRS ports A, B, E and/or F. In this event, the PTRS port may be mapped within REs with even indices within one RB containing the PTRS port. For example, the PTRS port may be restricted within REs with indices {0, 2, 4, 6, 8, 10} within one RB containing the PTRS port. For example, the PTRS port can be mapped to one of the REs.

In some other embodiments, the PTRS port may be associated with DMRS CDM group 1, such as DMRS ports C, D, G and/or H. In this event, the PTRS port may be mapped within REs with odd indices within one RB containing the PTRS port. For example, the PTRS port may be restricted within REs with indices {1, 3, 5, 7, 9, 11} within one RB containing the PTRS port. For example, the PTRS port can be mapped to one of the REs.

In one embodiment, for DMRS type 1, the RE index of the PTRS port can be represented as:

$$\{ \begin{matrix}\begin{matrix}⌊ R / 2 ⌋ * 2 , if the PTRS port is associated with a DMRS port \\ from CDM group 0\end{matrix} \\ \begin{matrix}⌊ R / 2 ⌋ * 2 + 1 , if the PTRS port is associated with a DMRS port \\ from CDM group 1\end{matrix}\end{matrix} \qquad ( 1 )$$

where R is a potential index implicitly derived from one or more parameters (e.g. an associated DMRS port index, SCID, Cell ID, etc.). In another embodiment, for DMRS type 1, the RE index of the PTRS port can be represented as:

$$\{ \begin{matrix}\begin{matrix}( R mod6 ) * 2 , if the PTRS port is associated with a DMRS \\ port from CDM group 0\end{matrix} \\ \begin{matrix}( R mod6 ) * 2 + 1 , if the PTRS port is associated with a DMRS \\ port from CDM group 1\end{matrix}\end{matrix} \qquad ( 2 )$$

where R is a potential index implicitly derived from one or more parameters (e.g. an associated DMRS port index, SCID, Cell ID, etc.)

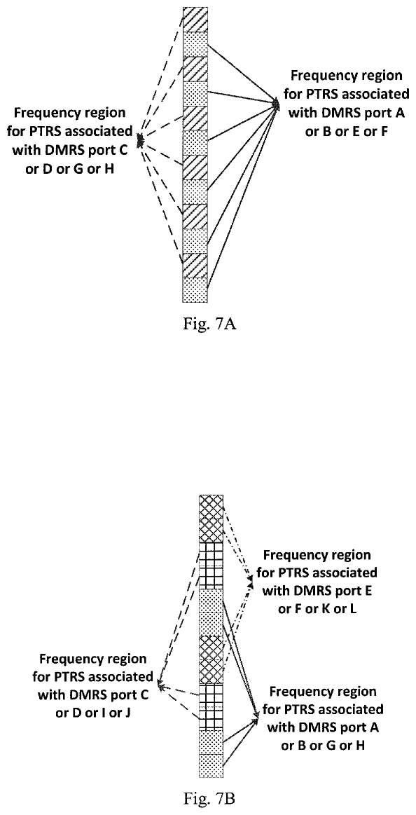

FIG. 7A shows an example of such embodiment. Specifically, FIG. 7A shows an example PTRS mapping pattern within one PRB in frequency domain for DMRS type 1. It is to be understood that the example as shown in FIG. 7A is only for the purpose of illustration without suggesting any limitations to the present disclosure. The embodiments of the present disclosure are applicable to DMRS type 1 with one or two symbols of front-loaded DMRS.

As shown in FIGS. 6C and 6D, for DMRS type 2, there may be three CDM groups, such as group 0, group 1 and group 2.

In one embodiment, the PTRS port may be associated with DMRS CDM group 0, such as DMRS ports A, B, G and/or H. In this event, the PTRS port may be mapped within REs with indices {0, 1, 6, 7} within RB(s) containing the PTRS port. In another embodiment, the PTRS port may be associated with DMRS CDM group 1, such as DMRS ports C, D, I and/or J. In this event, the PTRS port may be mapped within REs with indices {2, 3, 8, 9} within RB(s) containing the PTRS port. In yet another embodiment, the PTRS port may be associated with DMRS CDM group 2, such as DMRS ports E, F, K and/or L. In this event, the PTRS port may be mapped within REs with indices {4, 5, 10, 11} within RB(s) containing the PTRS port. For example, the PTRS port can be mapped to one RE in the restricted RE set.

In one embodiment, for DMRS type 2, the RE index of the PTRS port can be represented as:

$$\{ \begin{matrix}( R mod 4 ) + k , if ( R mod 4 ) = 0 or 1 \\ ( R mod 4 ) + k + 6 , if ( R mod 4 ) = 2 or 3\end{matrix} \qquad ( 3 )$$

where R is a potential index implicitly derived from one or more parameters (e.g. associated DMRS port index, SCID, Cell ID, etc.), and where:

$$\{ \begin{matrix}\begin{matrix}k = 0 , if the PTRS port is associated with a DMRS port \\ from CDM group 0\end{matrix} \\ \begin{matrix}k = 2 , if the PTRS port is associated with a DMRS port \\ from CDM group 1\end{matrix} \\ \begin{matrix}k = 4 , if the PTRS port is associated with a DMRS port \\ from CDM group 2\end{matrix}\end{matrix} \qquad ( 4 )$$

In another embodiment, for DMRS type 2, the RE index of the PTRS port can be represented as:

$$\{ \begin{matrix}⌊ R / 4 ⌋ + k , if ⌊ R / 4 ⌋ = 0 or 1 \\ ⌊ R / 4 ⌋ + k + 6 , if ⌊ R / 4 ⌋ = 2 or 3\end{matrix} \qquad ( 5 )$$

where R is the potential index implicitly derived from one or more parameters (e.g. associated DMRS port index, SCID, Cell ID, etc.), and where:

$$\{ \begin{matrix}\begin{matrix}k = 0 , if the PTRS port is associated with a DMRS port \\ from CDM group 0\end{matrix} \\ \begin{matrix}k = 2 , if the PTRS port is associated with a DMRS port \\ from CDM group 1\end{matrix} \\ \begin{matrix}k = 4 , if the PTRS port is associated with a DMRS port \\ from CDM group 2\end{matrix}\end{matrix} \qquad ( 6 )$$

FIG. 7B shows an example of such embodiment. Specifically, FIG. 7B shows an example PTRS mapping pattern within one PRB in frequency domain for DMRS type 2. It is to be understood that the example as shown in FIG. 7B is only for the purpose of illustration without suggesting any limitations to the present disclosure. The embodiments of the present disclosure are applicable to DMRS type 2 with one or two symbols of front-loaded DMRS.

In some embodiments, a subset of DMRS ports for DL or UL data transmission can be configured, and there may be several REs within one of the configured subset of DMRS ports. The restricted frequency region for PTRS may be same as or included in the REs of the configured subset of DMRS ports. For example, in one embodiment, for DMRS type 1 and/or DMRS type 2, the network device 110 may preconfigure the terminal device 120 with a subset of DMRS ports and/or a subset of DMRS CDM groups via higher layer signaling. In this event, the subcarrier selected for the PTRS port may be restricted within the REs corresponding to the subset of DMRS ports and/or the subset of DMRS CDM groups.

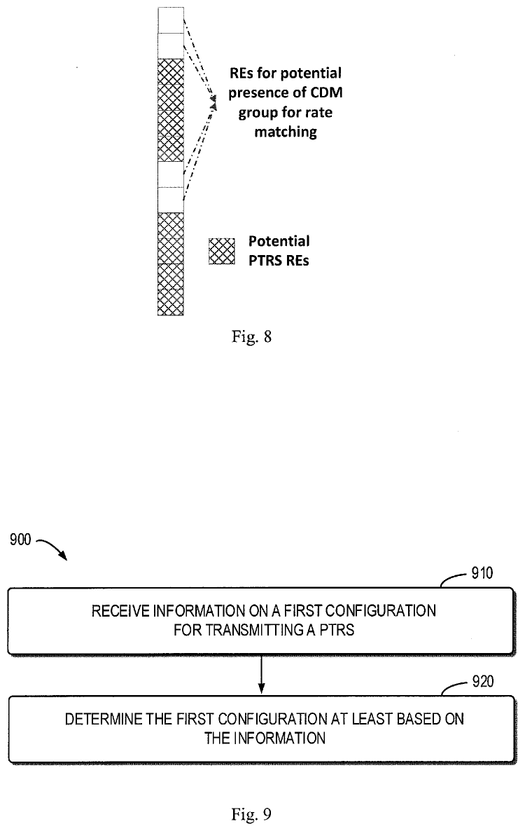

In some embodiments, the terminal device 110 may be configured with potential presence of one or more co-scheduled DL DMRS CDM groups for rate matching. In this event, the selected subcarrier for mapping PTRS may not be overlapped with the REs occupied by the configured one or more CDM groups. FIG. 8 shows an example of such embodiments. For example, in one embodiment, if the subcarrier selected based on an implicit RE offset is overlapped with the REs for rate matching, the subcarrier for PTRS mapping may be shifted to the closest RE(s) which is not overlapped with the REs for rate matching. Specifically, in one embodiment, during the shifting of the subcarrier for PTRS, if the distance from current position to an upper RE is the same as that to a lower RE, either the upper RE or the lower RE can be used as a destination position of the shifting. In one embodiment, a variable can be included in the formula for deriving the RE offset, so as to avoid the overlapping.

In some embodiments, for one-symbol front-loaded DMRS, the symbol location of the front-loaded DMRS may be represented as l′. The number of additional DMRSs n may be 0, 1, 2 or 3. The position of an additional DMRS may be represented as l̅ᵢ, where i is an index of the additional DMRS, and 0≤i≤n−1. Specifically, if there is no additional DMRS, there is no l̅. If PTRS exists, the time density of the PTRS may be represented as 1/D. For example, D may be 1, 2 or 4. The position of the last PDSCH or PUSCH symbol may be represented as L. In some embodiments, the PTRS may be located in different ranges of symbols in time domain. Note that, the index of the symbol starts from 0. In some embodiments, if the number of symbols in a range is less than D, there may be no PTRS transmission in the range.

In some embodiments, if there is no additional DMRS, the ranges of symbols may include a first range including symbol(s) before the front-loaded DMRS symbol l′, and a second range including symbol(s) after the front-loaded DMRS symbol l′ until the last PDSCH or PUSCH symbol L. In one embodiment, for the first range, the PTRS may exist in symbol l if l mod D=0, where 0≤l<l′. In another embodiment, there may be no PTRS transmission in the first range. In another embodiment, for the second range, the PTRS may exist in symbol l if (l−l′) mod D=0, where l′<l≤L.

In some embodiments, if there is one additional DMRS, the ranges of symbols may include a first range including symbol(s) before the front-loaded DMRS symbol l′, a second range including symbol(s) after the front-loaded DMRS symbol l′ but before the additional DMRS symbol l̅₀, and a third range including symbol(s) after the additional DMRS symbol l̅₀ until the last PDSCH or PUSCH symbol L. In one embodiment, for the first range, the PTRS may exist in symbol l if l mod D=0, where 0≤l<l′. In another embodiment, there may be no PTRS transmission in the first range. In another embodiment, for the second range, the PTRS may exist in symbol l if (l−l′) mod D=0, where l′<l<l̅₀. In another embodiment, for the third range, the PTRS may exist in symbol l if (l−l̅₀) mod D=0, where l̅₀<l≤L.

In some embodiments, if there are two additional DMRSs, the ranges of symbols may include a first range including symbol(s) before the front-loaded DMRS symbol l′, a second range including symbol(s) after the front-loaded DMRS symbol l′ but before the first additional DMRS symbol l̅₀, a third range including symbol(s) after the first additional DMRS symbol l̅₀ but before the second additional DMRS symbol l̅₁, and a fourth range including symbol(s) after the second additional DMRS symbol l̅₁ until the last PDSCH or PUSCH symbol L. In one embodiment, for the first range, the PTRS may exist in symbol l if l mod D=0, where 0≤l<l′. In another embodiment, there may be no PTRS transmission in the first range. In another embodiment, for the second range, the PTRS may exist in symbol l if (l−l′) mod D=0, where l′<l<l̅₀. In another embodiment, for the third range, the PTRS may exist in symbol l if (l−l̅₀) mod D=0, where l̅₀<l<l̅₁. In another embodiment, for the fourth range, the PTRS may exist in symbol l if (l−l̅₁) mod D=0, where l̅₁<l≤L.

In some embodiments, if there are three additional DMRSs, the ranges of symbols may include a first range including symbol(s) before front-loaded DMRS symbol l′, a second range including symbol(s) after front-loaded DMRS symbol l′ but before the first additional DMRS symbol l̅₀, a third range including symbol(s) after the first additional DMRS symbol l̅₀ but before the second additional DMRS symbol l̅₁, a fourth range including symbol(s) after the second additional DMRS symbol l̅₁ but before the third additional DMRS symbol l̅₂, and a fifth range including symbol(s) after the third additional DMRS symbol l̅₂ and until the last PDSCH or PUSCH symbol L. In one embodiment, for the first range, the PTRS may exist in symbol l if l mod D=0, where 0≤l<l′. In another embodiment, there may be no PTRS transmission in the first range. In another embodiment, for the second range, the PTRS may exist in symbol l if (l−l′) mod D=0, where l′<l<l̅₀. In another embodiment, for the third range, the PTRS may exist in symbol l if (l−l̅₀) mod D=0, where l̅₀<l<l̅₁. In another embodiment, for the fourth range, the PTRS may exist in symbol l if (l−l̅₁) mod D=0, where l̅₁<l<l̅₂. In another embodiment, for the fifth range, the PTRS may exist in symbol l if (l−l̅₂) mod D=0, where l̅₂<l≤L.

In some embodiments, for two-symbol front-loaded DMRS, the symbol location of the front-loaded DMRS may be represented as l′ⱼ, where j is an index of the symbol of front-loaded DMRS, and j=0, 1. The number of additional DMRSs n may be 0, 1. The position of an additional DMRS may be represented as l̅ᵢ, where i is an index of the symbol of additional DMRS, and i=0, 1. Specifically, if there is no additional DMRS, there is no l̅. If PTRS exists, the time density of the PTRS may be represented as 1/D. For example, D may be 1, 2 or 4. The position of the last PDSCH or PUSCH symbol may be represented as L. In some embodiments, the PTRS may be located in different ranges of symbols in time domain. Note that, the index of the symbol starts from 0. In some embodiments, if the number of symbols in a range is less than D, there may be no PTRS transmission in the range.

In some embodiments, if there is no additional DMRS, the ranges of symbols may include a first range including symbol(s) before the first front-loaded DMRS symbol l′₀, and a second range including symbol(s) after the second front-loaded DMRS symbol l′₁ until the last PDSCH or PUSCH symbol L. In one embodiment, for the first range, the PTRS may exist in symbol l if l mod D=0, where 0≤l<l′₁. In another embodiment, there may be no PTRS transmission in the first range. In another embodiment, for the second range, the PTRS may exist in symbol l if (l−l′₁) mod D=0, where l′₁<l≤L.

In some embodiments, if there is one additional DMRS, the ranges of symbols may include a first range including symbol(s) before the first front-loaded DMRS symbol l′₀, a second range including symbol(s) after the second front-loaded DMRS symbol l′ but before the first additional DMRS symbol l̅₀, and a third range including symbol(s) after the second additional DMRS symbol l̅₁ until the last PDSCH or PUSCH symbol L. In one embodiment, for the first range, the PTRS may exist in symbol l if l mod D=0, where 0≤l<l′₀. In another embodiment, there may be no PTRS transmission in the first range. In another embodiment, for the second range, the PTRS may exist in symbol l if (l−l′₁) mod D=0, where l′₁<l<l̅₀. In another embodiment, for the third range, the PTRS may exist in symbol l if (l−l̅₁) mod D=0, where l̅₁<l≤L.

In some embodiments, if the PTRS exists, the time density of the PTRS is ¼ and the number of symbols in a range is less than 4, there may be no PTRS transmission in the range. In some embodiments, if the PTRS exists, the time density of PTRS is ¼ and the number of symbols in a range is any of 4, 5, 8, 9, 12 or 13, the location for the PTRS in time domain may be associated with an offset. For example, the PTRS may exist in one symbol before the symbol l as described in above embodiments. For example, the PTRS may exist in one symbol immediately before the symbol l (that is, the symbol l−1), where l is the symbol determined in above embodiments. For example, the PTRS may exist in symbol l if (l−m) mod 4=3, where the symbol m may be any of the following: the only symbol for one-symbol front-loaded DMRS, the second symbol for two-symbol front-loaded DMRS, the only symbol for one-symbol additional DMRS, or the second symbol for two-symbol additional DMRS.

In some embodiments, if the number of DMRS ports configured for a terminal device is no greater than X, where X is an integer and X is any of 1, 2 or 4, the number of PTRS ports may be only one. In some embodiments, if the DMRS ports configured for the terminal device is from only one CDM group, the number of PTRS ports configured for the terminal device may be only one. In some embodiments, if the number of PTRS ports is greater than 1, the number of DMRS ports configured for the terminal device may be greater than X. For example, X may be no less than 1. In some embodiments, if the number of PTRS ports is greater than 1, the DMRS ports configured for the terminal device may be from different CDM groups. For example, the configured DMRS ports may come from two CDM groups for DMRS type 1. For example, the configured DMRS ports may come from two or three CDM groups for DMRS type 2.

Returning to FIG. 3, in act 320, the network device 110 transmits information on the first configuration to a terminal device 120. In some embodiments, the information on the first configuration can be transmitted via higher layer signaling and/or dynamic signaling by the network device 110. In some embodiments, the terminal device 120 may be configured with one or more DMRS ports for DMRS transmission. In this event, the first configuration may only indicate an association between the PTRS port and one of the one or more DMRS ports. In some embodiments, the restrictions for the PTRS port as described above can be preconfigured in both the network device 110 and the terminal device 120. That is, the terminal device 120 can determine the detailed PTRS mapping in both time and frequency domain based on the information received from the network device 110 and the preconfigured restrictions. Therefore, the signaling overhead for indicating the PTRS configuration can be reduced.

FIG. 9 shows a flowchart of an example method 900 in accordance with some embodiments of the present disclosure. The method 900 can be implemented at a terminal device 120 as shown in FIG. 1. For the purpose of discussion, the method 900 will be described from the perspective of the terminal device 120 with reference to FIG. 1.

In act 910, the terminal device 120 receives, from the network device 110, information on a first configuration for transmitting a PTRS.

In act 920, the terminal device 120 determines the first configuration at least based on the information. In some embodiments, the first configuration indicates at least one of the following: a first density of the PTRS in time domain, a second density of the PTRS in frequency domain, first resource allocation for the PTRS in time domain, and second resource allocation for the PTRS in frequency domain.

In some embodiments, the PTRS may be associated with at least one DMRS, and the information indicates an association between the first configuration and a predetermined second configuration for transmitting the at least one DMRS. The terminal device 120 may determine the first configuration based on the information and the predetermined second configuration.

In some embodiments, the restrictions for the PTRS port may be preconfigured in both the network device 110 and the terminal device 120. The terminal device 120 may determine the resource allocation for PTRS in both time and frequency domain based on the information received from the network device 110 and the preconfigured restrictions.

For example, in some embodiments, the at least one DMRS includes a front-loaded DMRS and a number of additional DMRSs. The terminal device 120 may determine a set of candidate densities for the first density at least in part based on at least one of the following: the number of additional DMRSs, the number of symbols for transmitting the front-loaded DMRS, the number of symbols for control channel transmission, the number of DMRS ports, the number of CDM groups, a frequency range, and a subcarrier spacing value. The first density in time domain may be selected from the set of candidate densities.

In some embodiments, the terminal device 120 may determine the first resource allocation in time domain at least in part based on a predetermined set of symbols, the predetermined second configuration and the first density. The first resource allocation may indicate at least a part of the predetermined set of symbols for transmitting the PTRS.

In some embodiments, the terminal device 120 may determine the second density of the PTRS in frequency domain at least in part based on a predetermined or configured bandwidth.

In some embodiments, the predetermined or configured bandwidth may correspond to a set of RBs. A RB offset within the set of RBs associated with the PTRS may be determined. The terminal device 120 may determine the second resource allocation in frequency domain at least in part based on the second density of the PTRS in frequency domain, the set of RBs, the RB offset and a predetermined type of resource allocation. The second resource allocation may indicate at least a part of the set of RBs for transmitting the PTRS.

In some embodiments, a predetermined set of symbols may be divided into different regions. The terminal device 120 may determine the second resource allocation in frequency domain at least in part based on the different regions. For example, the second resource allocation in frequency domain may indicate respective RBs for transmitting the PTRS in the different regions.

In some embodiments, the at least a part of the set of RBs containing PTRS include at least one RB. The at least one RB includes a plurality of REs. A RE offset within the at least one RB may be determined. The terminal device 120 may determine the second resource allocation in frequency domain at least in part based on the plurality of REs and the RE offset. The second resource allocation may further indicate at least a part of the plurality of REs for transmitting the PTRS.

In some embodiments, the predetermined second configuration may indicate a type of the at least one DMRS and a group of DMRS ports for DMRS transmission. The terminal device 120 can determine the second resource allocation for PTRS at least in part based on the type of the at least one DMRS and the group of DMRS ports for DMRS transmission.

It is to be understood that at least a part of operations and features related to the network device 110 for restricting the PTRS configuration as described above with reference to FIGS. 3-8 are likewise applicable to the method 900 and have similar effects. For the purpose of simplification, the details will be omitted.

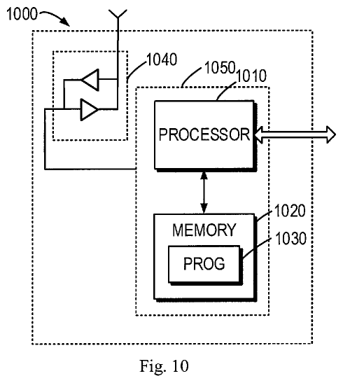

FIG. 10 is a simplified block diagram of a device 1000 that is suitable for implementing embodiments of the present disclosure. The device 1000 can be considered as a further example implementation of a network device 110 or a terminal device 120 as shown in FIG. 1. Accordingly, the device 1000 can be implemented at or as at least a part of the network device 110 or the terminal device 120.

As shown, the device 1000 includes a processor 1010, a memory 1020 coupled to the processor 1010, a suitable transmitter (TX) and receiver (RX) 1040 coupled to the processor 1010, and a communication interface coupled to the TX/RX 1040. The memory 1010 stores at least a part of a program 1030. The TX/RX 1040 is for bidirectional communications. The TX/RX 1040 has at least one antenna to facilitate communication, though in practice an Access Node mentioned in this application may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 1030 is assumed to include program instructions that, when executed by the associated processor 1010, enable the device 1000 to operate in accordance with the embodiments of the present disclosure, as discussed herein with reference to FIGS. 1 to 9. The embodiments herein may be implemented by computer software executable by the processor 1010 of the device 1000, or by hardware, or by a combination of software and hardware. The processor 1010 may be configured to implement various embodiments of the present disclosure. Furthermore, a combination of the processor 1010 and memory 1010 may form processing means 1050 adapted to implement various embodiments of the present disclosure.

The memory 1010 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1010 is shown in the device 1000, there may be several physically distinct memory modules in the device 1000. The processor 1010 may be of any type suitable to the local technical network, and may include one or more of general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to any of FIGS. 1 to 9. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-26. (canceled)

27. A terminal comprising a processor configured to:
receive, from a network device, an RE offset via RRC (Radio Resource Control) layer signaling;
map each of PTRSs to each of subcarriers for each of DMRS pols associated with each of PTRS ports based on a DMRS configuration type and the RE offset; and
transmit, to the network device, the PTRSs mapped to the subcarriers, wherein
the DMRS configuration type is one of DMRS configuration type 1 or DMRS configuration type 2, wherein
the DMRS configuration type 1 supports two CDM groups to which the DMRS ports belong; and
the DMRS configuration type 2 supports three CDM groups to which the DMRS ports belong, wherein
for DMRS configuration type 1,
each of the PTRSs are mapped to one of subcarriers {0, 2, 4, 6, 8, 10} if the PTRS ports for the PTRSs are associated with the DMRS ports belonging to CDM group 0, wherein
the RE offset is used for selecting the one from the subcarriers {0, 2, 4, 6, 8, 10}; and
each of the PTRSs are mapped to one of subcarriers {1, 3, 5, 7, 9, 11} if the PTRS ports for the PTRSs are associated with the DMRS pots belonging to CDM group 1, wherein
the RE offset is used for selecting the one from the subcarriers {1, 3, 5, 7, 9, 11}, and
for DMRS configuration type 2,
each of the PTRSs are mapped to one of subcarriers {0, 1, 6, 7} if the PTRS ports for the PTRSs are associated with the DMRS ports belonging to CDM group 0, wherein
the RE offset is used for selecting the one from the subcarriers {0, 1, 6, 7};
each of the PTRSs are mapped to one of subcarriers {2, 3, 8, 9} if the PTRS ports for the PTRSs are associated with the DMRS ports belonging to CDM group 1, wherein
the RE offset is used for selecting the one from the subcarriers {2, 3, 8, 9}; and
each of the PTRSs are mapped to one of subcarriers {4, 5, 10, 11} if the PTRS ports for the PTRSs are associated with the DMRS ports belonging to CDM group 2, wherein
the RE offset is used for selecting the one from the subcarriers {4, 5, 10, 11}.

28. A terminal comprising a processor configured to:
receive, from a network device, an RE offset via RRC (Radio Resource Control) layer signaling;
receive, from the network device, PTRSs mapped to subcarriers; and
detect each of the PTRSs mapped to each of the subcarriers for each of DMRS ports associated with each of PTRS ports based on a DMRS configuration type and the RE offset, wherein
the DMRS configuration type is one of DMRS configuration type 1 or DMRS configuration type 2, wherein
the DMRS configuration type 1 supports two CDM groups to which the DMRS ports belong; and
the DMRS configuration type 2 supports three CDM groups to which the DMRS ports belong, wherein
for DMRS configuration type 1,
each of the PTRSs are mapped to one of subcarriers {0, 2, 4, 6, 8, 10} if the PTRS ports for the PTRSs are associated with the DMRS ports belonging to CDM group 0, wherein
the RE offset is used for selecting the one from the subcarriers {0, 2, 4, 6, 8, 10}; and
each of the PTRSs are mapped to one of subcarriers {1, 3, 5, 7, 9, 11} if the PTRS ports for the PTRSs are associated with the DMRS ports belonging to CDM group 1, wherein
the RE offset is used for selecting the one from the subcarriers {1, 3, 5, 7, 9, 11}.

29. The terminal according to claim 28, wherein
for DMRS configuration type 2,
each of the PTRSs are mapped to one of subcarriers {0, 1, 6, 7} if the PTRS ports for the PTRSs are associated with the DMRS ports belonging to CDM group 0, wherein
the RE offset is used for selecting the one from the subcarriers {0, 1, 6, 7};
each of the PTRSs are mapped to one of subcarriers {2, 3, 8, 9} if the PTRS ports for the PTRSs are associated with the DMRS ports belonging to CDM group 1, wherein
the RE offset is used for selecting the one from the subcarriers {2, 3, 8, 9}; and
each of the PTRSs are mapped to one of subcarriers {4, 5, 10, 11} if the PTRS ports for the PTRSs are associated with the DMRS ports belonging to CDM group 2, wherein
the RE offset is used for selecting the one from the subcarriers {4, 5, 10, 11}.

30. A network device comprising a processor configured to:
transmit, to a terminal, an RE offset via RRC (Radio Resource Control) layer signaling;
receive, from the terminal, PTRSs mapped to subcarriers; and
detect each of the PTRSs mapped to each of the subcarriers for each of DMRS ports associated with each of PTRS ports based on a DMRS configuration type and the RE offset, wherein
the DMRS configuration type is one of DMRS configuration type 1 or DMRS configuration type 2, wherein
the DMRS configuration type 1 supports two CDM groups to which the DMRS ports belong; and
the DMRS configuration type 2 supports three CDM groups to which the DMRS ports belong, wherein
for DMRS configuration type 1,
each of the PTRSs are mapped to one of subcarriers {0, 2, 4, 6, 8, 10} if the PTRS ports for the PTRSs are associated with the DMRS ports belonging to CDM group 0, wherein
the RE offset is used for selecting the one from the subcarriers {10, 2, 4, 6, 8, 10}; and
each of the PTRSs are mapped to one of subcarriers {1, 3, 5, 7, 9, 11} if the PTRS ports for the PTRSs are associated with the DMRS ports belonging to CDM group 1, wherein
the RE offset is used for selecting the one from the subcarriers {1, 3, 5, 7, 9, 11}, and
for DMRS configuration type 2,
each of the PTRSs are mapped to one of subcarriers {0, 1, 6, 7} if the PTRS ports for the PTRSs are associated with the DMRS ports belonging to CDM group 0, wherein
the RE offset is used for selecting the one from the subcarriers {0, 1, 6, 7};
each of the PTRSs are mapped to one of subcarriers {2, 3, 8, 9} if the PTRS ports for the PTRSs are associated with the DMRS ports belonging to CDM group 1, wherein
the RE offset is used for selecting the one from the subcarriers {2, 3, 8, 9}; and
each of the PTRSs are mapped to one of subcarriers {4, 5, 10, 11} if the PTRS ports for the PTRSs are associated with the DMRS ports belonging to CDM group 2, wherein
the RE offset is used for selecting the one from the subcarriers {4, 5, 10, 11}.

31. A network device comprising a processor configured to:
transmit, to a terminal, an RE offset via RRC (Radio Resource Control) layer signaling;
map each of PTRSs to each of subcarriers for each of DMRS ports associated with each of PTRS ports based on a DMRS configuration type and the RE offset; and
transmit, to the terminal, the PTRSs mapped to the subcarriers, wherein
the DMRS configuration type is one of DMRS configuration type 1 or DMRS configuration type 2, wherein
the DMRS configuration type 1 supports two CDM groups to which the DMRS ports belong; and
the DMRS configuration type 2 supports three CDM groups to which the DMRS ports belong, wherein
for DMRS configuration type 1,
each of the PTRSs are mapped to one of subcarriers {0, 2, 4, 6, 8, 10} if the PTRS ports for the PTRSs are associated with the DMRS ports belonging to CDM group 0, wherein
the RE offset is used for selecting the one from the subcarriers {0, 2, 4, 6, 8, 10}; and
each of the PTRSs are mapped to one of subcarriers {1, 3, 5, 7, 9, 11} if the PTRS ports for the PTRSs are associated with the DMRS ports belonging to CDM group 1, wherein
the RE offset is used for selecting the one from the subcarriers {1, 3, 5, 7, 9, 11}.

32. The network device according to claim 31, wherein
for DMRS configuration type 2,
each of the PTRSs are mapped to one of subcarriers {0, 1, 6, 7} if the PTRS ports for the PTRSs are associated with the DMRS ports belonging to CDM group 0, wherein
the RE offset is used for selecting the one from the subcarriers {0, 1, 6.7};
each of the PTRSs are mapped to one of subcarriers {2, 3, 8, 9} if the PTRS ports for the PTRSs are associated with the DMRS ports belonging to CDM group 1, wherein
the RE offset is used for selecting the one from the subcarriers {2, 3, 8, 9}; and
each of the PTRSs are mapped to one of subcarriers {4, 5, 10, 11} if the PTRS ports for the PTRSs are associated with the DMRS ports belonging to CDM group 2, wherein
the RE offset is used for selecting the one from the subcarriers {4, 5, 10, 11}.

33. A method comprising:
receiving an RE offset via RRC (Radio Resource Control) layer signaling;
mapping each of PTRSs to each of subcarriers for each of DMRS ports associated with each of PTRS ports based on a DMRS configuration type and the RE offset; and
transmitting the PTRSs mapped to the subcarriers, wherein
the DMRS configuration type is one of DMRS configuration type 1 or DMRS configuration type 2, wherein
the DMRS configuration type 1 supports two CDM groups to which the DMRS ports belong; and
the DMRS configuration type 2 supports three CDM groups to which the DMRS ports belong, wherein
for DMRS configuration type 1,
each of the PTRSs are mapped to one of subcarriers {0, 2, 4, 6, 8, 10} if the PTRS ports for the PTRSs are associated with the DMRS ports belonging to CDM group 0, wherein
the RE offset is used for selecting the one from the subcarriers {0, 2, 4, 6, 8, 10}; and
each of the PTRSs are mapped to one of subcarriers {1, 3, 5, 7, 9, 11} if the PTRS ports for the PTRSs are associated with the DMRS ports belonging to CDM group 1, wherein
the RE offset is used for selecting the one from the subcarriers {1, 3, 5, 7, 9, 11}, and
for DMRS configuration type 2,
each of the PTRSs are mapped to one of subcarriers {0, 1, 6, 7} if the PTRS ports for the PTRSs are associated with the DMRS ports belonging to CDM group 0, wherein
the RE offset is used for selecting the one from the subcarriers {0, 1, 6, 7};
each of the PTRSs are mapped to one of subcarriers {2, 3, 8, 9} if the PTRS ports for the PTRSs are associated with the DMRS ports belonging to CDM group 1, wherein
the RE offset is used for selecting the one from the subcarriers {2, 3, 8, 9}; and
each of the PTRSs are mapped to one of subcarriers {4, 5, 10, 11} if the PTRS ports for the PTRSs are associated with the DMRS ports belonging to CDM group 2, wherein
the RE offset is used for selecting the one from the subcarriers {4, 5, 10, 11}.

34. A method comprising:
receiving an RE offset via RRC (Radio Resource Control) layer signaling;
receiving PTRSs mapped to subcarriers; and
detecting each of the PTRSs mapped to each of the subcarriers for each of DMRS ports associated with each of PTRS ports based on a DMRS configuration type and the RE offset, wherein
the DMRS configuration type is one of DMRS configuration type 1 or DMRS configuration type 2, wherein
the DMRS configuration type 1 supports two CDM groups to which the DMRS ports belong; and
the DMRS configuration type 2 supports three CDM groups to which the DMRS ports belong, wherein
for DMRS configuration type 1,
each of the PTRSs are mapped to one of subcarriers {0, 2, 4, 6, 8, 10} if the PTRS ports for the PTRSs are associated with the DMRS ports belonging to CDM group 0, wherein
the RE offset is used for selecting the one from the subcarriers {0, 2, 4, 6, 8, 10}; and
each of the PTRSs are mapped to one of subcarriers {1, 3, 5, 7, 9, 11} if the PTRS ports for the PTRSs are associated with the DMRS ports belonging to CDM group 1, wherein
the RE offset is used for selecting the one from the subcarriers {1, 3, 5, 7, 9, 11}.

35. The method according to claim 34, wherein
for DMRS configuration type 2,
each of the PTRSs are mapped to one of subcarriers {0, 1, 6, 7} if the PTRS ports for the PTRSs are associated with the DMRS ports belonging to CDM group 0, wherein
the RE offset is used for selecting the one from the subcarriers {0, 1, 6, 7};
each of the PTRSs are mapped to one of subcarriers {2, 3, 8, 9} if the PTRS ports for the PTRSs are associated with the DMRS ports belonging to CDM group 1, wherein
the RE offset is used for selecting the one from the subcarriers {2, 3, 8, 9}; and
each of the PTRSs are mapped to one of subcarriers {4, 5, 10, 11} if the PTRS ports for the PTRSs are associated with the DMRS ports belonging to CDM group 2, wherein
the RE offset is used for selecting the one from the subcarriers {4, 5, 10, 11}.

36. A method comprising:
transmitting an RE offset via RRC (Radio Resource Control) layer signaling;
receiving PTRSs mapped to subcarriers; and
detecting each of the PTRSs mapped to each of the subcarriers for each of DMRS ports associated with each of PTRS ports based on a DMRS configuration type and the RE offset, wherein
the DMRS configuration type is one of DMRS configuration type 1 or DMRS configuration type 2, wherein
the DMRS configuration type 1 supports two CDM groups to which the DMRS ports belong; and
the DMRS configuration type 2 supports three CDM groups to which the DMRS ports belong, wherein
for DMRS configuration type 1,
each of the PTRSs are mapped to one of subcarriers {0, 2, 4, 6, 8, 10} if the PTRS ports for the PTRSs are associated with the DMRS ports belonging to CDM group 0, wherein
the RE offset is used for selecting the one from the subcarriers {0, 2, 4, 6, 8, 10}; and
each of the PTRSs are mapped to one of subcarriers {1, 3, 5, 7, 9, 11} if the PTRS ports for the PTRSs are associated with the DMRS ports belonging to CDM group 1, wherein
the RE offset is used for selecting the one from the subcarriers {1, 3, 5, 7, 9, 11}, and
for DMRS configuration type 2,
each of the PTRSs are mapped to one of subcarriers {0, 1, 6, 7} if the PTRS ports for the PTRSs are associated with the DMRS ports belonging to CDM group 0, wherein
the RE offset is used for selecting the one from the subcarriers {0, 1, 6, 7};
each of the PTRSs are mapped to one of subcarriers {2, 3, 8, 9} if the PTRS ports for the PTRSs are associated with the DMRS ports belonging to CDM group 1, wherein
the RE offset is used for selecting the one from the subcarriers {2, 3, 8, 9}; and
each of the PTRSs are mapped to one of subcarriers {4, 5, 10, 11} if the PTRS ports for the PTRSs are associated with the DMRS ports belonging to CDM group 2, wherein
the RE offset is used for selecting the one from the subcarriers {4, 5, 10, 11}.

37. A method comprising:
transmitting an RE offset via RRC (Radio Resource Control) layer signaling;
map each of PTRSs to each of subcarriers for each of DMRS pols associated with each of PTRS ports based on a DMRS configuration type and the RE offset; and
transmitting the PTRSs mapped to the subcarriers, wherein
the DMRS configuration type is one of DMRS configuration type 1 or DMRS configuration type 2, wherein
the DMRS configuration type 1 supports two CDM groups to which the DMRS ports belong; and
the DMRS configuration type 2 supports three CDM groups to which the DMRS ports belong, wherein
for DMRS configuration type 1,
each of the PTRSs are mapped to one of subcarriers {0, 2, 4, 6, 8, 10} if the PTRS ports for the PTRSs are associated with the DMRS ports belonging to CDM group 0, wherein
the RE offset is used for selecting the one from the subcarriers {0, 2, 4, 6, 8, 10}; and
each of the PTRSs are mapped to one of subcarriers {1, 3, 5, 7, 9, 11} if the PTRS ports for the PTRSs are associated with the DMRS pols belonging to CDM group 1, wherein
the RE offset is used for selecting the one from the subcarriers {1, 3, 5, 7, 9, 11}.

38. The method according to claim 37, wherein
for DMRS configuration type 2,
each of the PTRSs are mapped to one of subcarriers {0, 1, 6, 7} if the PTRS ports for the PTRSs are associated with the DMRS ports belonging to CDM group 0, wherein
the RE offset is used for selecting the one from the subcarriers {0, 1, 6, 7};
each of the PTRSs are mapped to one of subcarriers {2, 3, 8, 9} if the PTRS ports for the PTRSs are associated with the DMRS ports belonging to CDM group 1, wherein
the RE offset is used for selecting the one from the subcarriers {2, 3, 8, 9}; and
each of the PTRSs are mapped to one of subcarriers {4, 5, 10, 11} if the PTRS ports for the PTRSs are associated with the DMRS ports belonging to CDM group 2, wherein
the RE offset is used for selecting the one from the subcarriers {4, 5, 10, 11}.
